(19) United States
(12) Patent Application Publication
(10) Pub. No.: US 2020/0156710 A1
(43) Pub. Date: May 21, 2020

(54) INSTRUMENT PANEL REINFORCEMENT

(71) Applicant: AISIN SEIKI KABUSHIKI KAISHA, Kariya-shi (JP)

(72) Inventors: Syunji MORI, Kariya-shi (JP); Taichi ITAKURA, Kariya-shi (JP); Masaaki YOSHIMURA, Kariya-shi (JP); Yasuyoshi TAMAKOSHI, Kariya-shi (JP); Hiroshi NISHIMURA, Kariya-shi (JP); Takuya SUGIURA, Kariya-shi (JP); Masaru TAKAHASHI, Kariya-shi (JP); Takashi NUNOME, Kariya-shi (JP); Kiyoichi KITA, Okazaki-shi (JP)

(73) Assignee: AISIN SEIKI KABUSHIKI KAISHA, Kariya-shi (JP)

(21) Appl. No.: 16/685,453

(22) Filed: Nov. 15, 2019

(30) Foreign Application Priority Data
Nov. 16, 2018 (JP) 2018-215166

(51) Int. Cl. B62D 25/14; B62D 29/00

(52) U.S. Cl. CPC B62D 25/145; B62D 29/008

(57) ABSTRACT

An instrument panel reinforcement which extends in a vehicle width direction and of which both ends are fixed to a side surface of a vehicle at positions on a front side of an instrument panel in a vehicle front-rear direction includes a first support portion configured to support a steering mechanism, and a second support portion disposed in a row with the first support portion in a vehicle width direction and is detachably connected to the first support portion.

### CROSS-REFERENCE TO RELATED APPLICATION

This application claims priority to Japanese Patent Application No. 2018-215166 filed on Nov. 16, 2018, incorporated herein by reference in its entirety.

### BACKGROUND

### 1. Technical Field

The disclosure relates to an instrument panel reinforcement.

### 2. Description of Related Art

As related art documents which disclose a configuration for an instrument panel reinforcement, there are Japanese Unexamined Patent Application Publication No. 2014-61776 (JP 2014-61776 A), Japanese Unexamined Patent Application Publication No. 2013-28337 (JP 2013-28337 A), and Japanese Unexamined Patent Application Publication No. 2006-15880 (JP 2006-15880 A).

The instrument panel reinforcement disclosed in JP 2014-61776 A is made of a light alloy or a resin composite material. The instrument panel reinforcement disclosed in JP 2013-28337 A includes a cross member and a bracket, and the cross member and the bracket are all made of a magnesium alloy material. The instrument panel reinforcement disclosed in JP 2006-15880 A is made of a light alloy.

### SUMMARY

In the conventional instrument panel reinforcements, members which extend in the vehicle width direction are integrally formed. Therefore, handleability at the time of transportation of the instrument panel reinforcement is poor. Further, in the instrument panel reinforcement, it is difficult to replace a part of a portion which extends in the vehicle width direction.

The present disclosure provides an instrument panel reinforcement in which handleability during transportation is able to be improved and in which a part of a portion which extends in the vehicle width direction is able to be replaced easily.

According to an aspect of the present disclosure, there is provided an instrument panel reinforcement which extends in a vehicle width direction and of which both ends are fixed to a side surface of a vehicle at positions on a front side of an instrument panel in a vehicle front-rear direction. The instrument panel reinforcement includes a first support portion configured to support a steering mechanism, and a second support portion disposed aligned with the first support portion in the vehicle width direction and detachably connected to the first support portion.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of an instrument panel reinforcement according to an embodiment of the present disclosure when seen from behind in the vehicle front-rear direction;

FIG. 2 is a perspective view of the instrument panel reinforcement according to the embodiment of the present disclosure when seen from in front in the vehicle front-rear direction;

FIG. 3 is a front view of the instrument panel reinforcement according to the embodiment of the present disclosure when seen from behind in the vehicle front-rear direction;

FIG. 4 is a cross-sectional view of the instrument panel reinforcement shown in FIG. 3 when seen in a direction of arrows of line IV-IV;

FIG. 5 is a cross-sectional view of the instrument panel reinforcement shown in FIG. 3 when seen in a direction of arrows of line V-V;

FIG. 6 is a perspective view showing a state in which a connection between a first support portion and a second support portion is released in the instrument panel reinforcement according to the embodiment of the present disclosure;

FIG. 7 is a cross-sectional view of the instrument panel reinforcement 100 shown in FIG. 3 when seen in a direction of arrows of line VII-VII;

FIG. 8 is a cross-sectional view of the instrument panel reinforcement shown in FIG. 3 when seen in a direction of arrows of line VIII-VIII;

FIG. 9 is an SEM photograph showing a region in which a crystal grain size in a base member is measured in the instrument panel reinforcement according to the embodiment of the present disclosure; and

FIG. 10 is an SEM photograph showing a region in which a crystal grain size in a base member is measured in an instrument panel reinforcement according to a modified example of the embodiment of the present disclosure.

### DETAILED DESCRIPTION OF EMBODIMENTS

Hereinafter, an instrument panel reinforcement according to embodiments of the present disclosure will be described with reference to the drawings. In the following description of the embodiments, the same or corresponding parts in the drawings are designated by the same reference numerals, and the description thereof will not be repeated.

Also, in the drawings, the right side and the left side in the vehicle right and left direction when seen from the inside of the vehicle are respectively indicated by arrows X1 and X2, the front side and the rear side in the vehicle front-rear direction are respectively indicated by arrows Y1 and Y2, and the upper side and the lower side in the vehicle vertical direction are respectively indicated by arrows Z1 and Z2. These orientations can be applied to the instrument panel reinforcement in the state before it is mounted in a vehicle body and the state after it is mounted in a vehicle body.

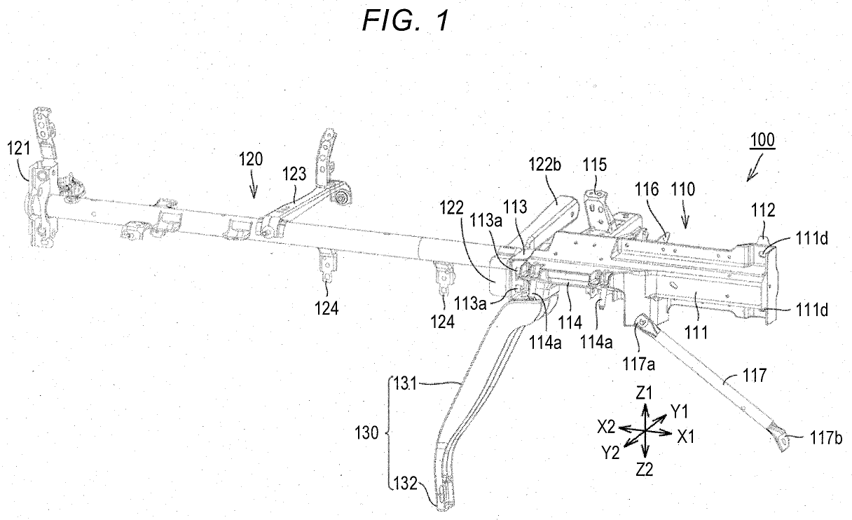

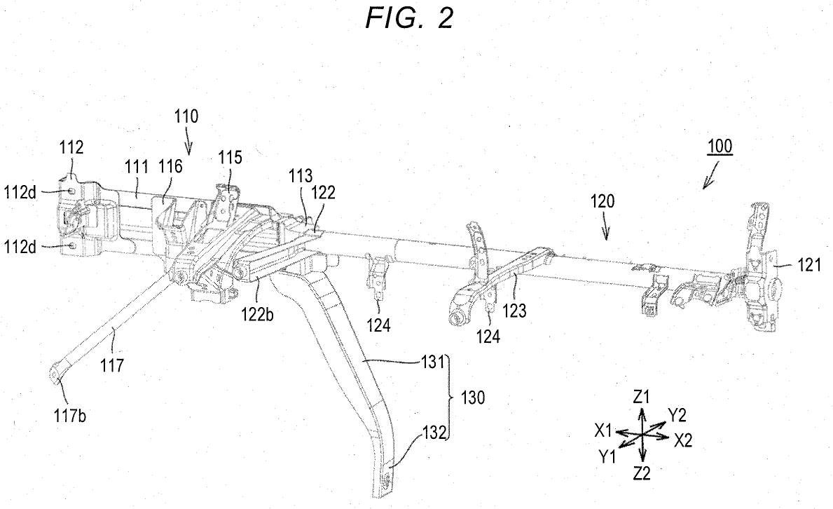

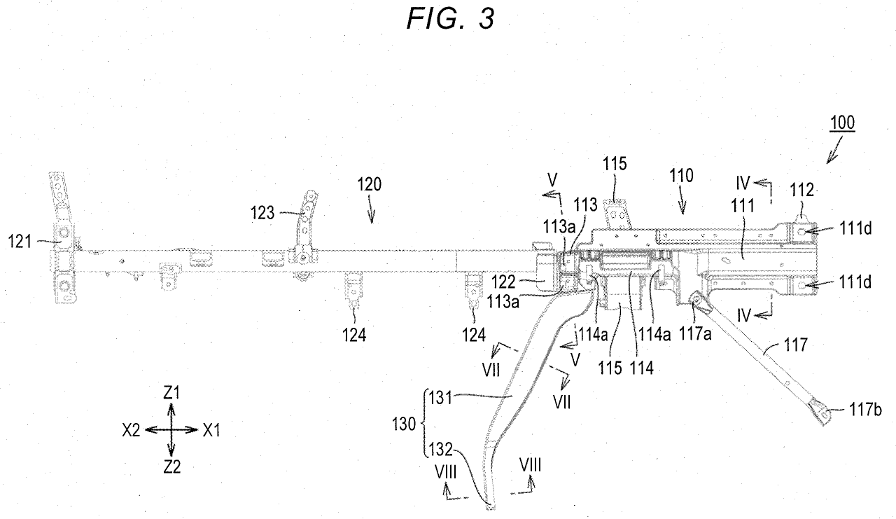

FIG. 1 is a perspective view of an instrument panel reinforcement according to an embodiment of the present disclosure when seen from behind in the vehicle front-rear direction. FIG. 2 is a perspective view of the instrument panel reinforcement according to the embodiment of the present disclosure when seen from in front in the vehicle front-rear direction. FIG. 3 is a front view of the instrument panel reinforcement according to the embodiment of the present disclosure when seen from behind in the vehicle front-rear direction. In FIGS. 1 to 3, members in the vehicle other than the instrument panel reinforcement are not shown.

As shown in FIGS. 1 to 3, the instrument panel reinforcement 100 according to the embodiment of the present disclosure extends in the vehicle width direction. Further, both ends of the instrument panel reinforcement 100 are fixed to side surfaces of the vehicle at a position in front of an instrument panel in the vehicle front-rear direction.

The instrument panel reinforcement 100 includes a first support portion 110, a second support portion 120, and a leg portion 130. The second support portion 120 is disposed aligned with the first support portion 110 in the vehicle width direction.

The instrument panel reinforcement 100 is fixed to the vehicle so that the first support portion 110 is located on the driver's seat side and the second support portion 120 is located on the passenger seat side. The instrument panel reinforcement 100 according to the embodiment is fixed to the vehicle so that the first support portion 110 is located on the right X1 side in the vehicle right and left direction and the second support portion 120 is located on the left X2 side of the vehicle when seen from the rear side Y2 in the vehicle front-rear direction.

In one embodiment of the present disclosure, the first support portion 110 includes a base member 111 and a reinforcing member 112.

The base member 111 extends in the vehicle width direction. A hole 111d is provided in an end portion of the base member 111 on the side opposite to the second support portion 120 side. A fastening tool such as a bolt is inserted into the hole 111d, and the base member 111 is fastened and fixed to the side surface of the vehicle body on the right X1 side in the vehicle right and left direction by the fastening tool.

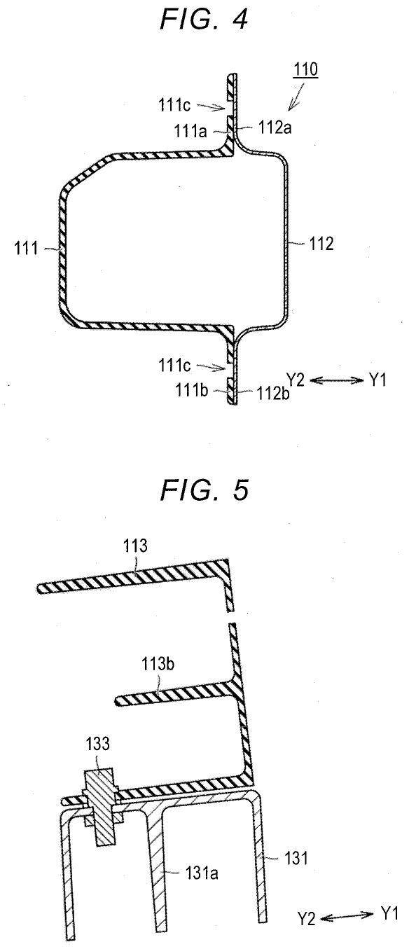

FIG. 4 is a cross-sectional view of the instrument panel reinforcement shown in FIG. 3 when seen in a direction of arrows of line IV-IV. As shown in FIGS. 1 to 4, in a portion located on the side opposite to the second support portion 120 side from a lower steering support portion 114 which will be described later, the base member 111 is formed so that a plate-shaped member extends in the vehicle width direction while curved convexly toward the rear Y2 side in the vehicle front-rear direction.

As shown in FIG. 4, the base member 111 includes an upper extending portion 111a which extends from an upper end of a curved portion, and a lower extending portion 111b which extends from a lower end of the curved portion. A hole 111c which penetrates in the front and rear direction in the vehicle front-rear direction is provided in each of the upper extending portion 111a and the lower extending portion 111b.

The base member 111 is made of a material containing magnesium or aluminum. In the embodiment, the base member 111 is made of a material containing magnesium. Specifically, the base member 111 is made of a polycrystalline magnesium alloy. In this way, at least a part of the first support portion 110 is made of a material containing magnesium or aluminum. In the embodiment, at least a part of the first support portion 110 is made of a polycrystalline magnesium alloy.

As shown in FIGS. 1 to 4, the reinforcing member 112 is joined to the front side of the base member 111 in the vehicle front-rear direction. Specifically, the reinforcing member 112 is bent at an end portion of the base member 111 on the side opposite to the second support portion 120 side and is joined to the base member 111 to cover an end surface of the end portion on the right X1 side in the vehicle right and left direction and the front Y1 side of the end portion in the vehicle front-rear direction.

As shown in FIGS. 2 and 4, a part of the reinforcing member 112 is formed to be curved convexly toward the front Y1 side in the vehicle front-rear direction. The reinforcing member 112 includes an upper extending portion 112a which extends from an upper end of a curved portion and a lower extending portion 112b which extends from a lower end of the curved portion.

The upper extending portion 112a of the reinforcing member 112 is located in an extending direction of the upper extending portion 111a of the base member 111. The upper extending portion 112a of the reinforcing member 112 is joined to the upper extending portion 111a of the base member 111. Further, the lower extending portion 112b of the reinforcing member 112 is located in an extending direction of the lower extending portion 111b of the base member 111. The lower extending portion 112b of the reinforcing member 112 is joined to the lower extending portion 111b of the base member 111.

In the embodiment, a convex member (not shown) having a convex portion is fitted into the hole 111c formed in each of the upper extending portion 111a and the lower extending portion 111b of the base member 111. The convex member and the reinforcing member 112 are joined by resistance welding. Thus, the upper extending portions of the base member 111 and the reinforcing member 112 are joined to each other. Further, the lower extending portions of the base member 111 and the reinforcing member 112 are joined to each other.

The method of joining the base member 111 and the reinforcing member 112 to each other is not limited to resistance welding. When each of the base member 111 and the reinforcing member 112 is made of the same material, a hole may be provided at a position corresponding to the hole 111c of the reinforcing member 112, a rivet having a convex shape may be inserted through the hole 111c and the hole of the reinforcing member 112 from the base member 111 side, and the base member 111 and the reinforcing member 112 may be joined to each other by caulking the rivet.

As shown in FIG. 2, the reinforcing member 112 includes a hole 112d. Also, as shown in FIGS. 1 and 2, the hole 112d of the reinforcing member 112 is located to substantially coincide with the hole 111d of the base member 111 when seen from the rear Y2 side in the vehicle front-rear direction. The reinforcing member 112 is fixed to the vehicle body together with the base member 111 by a fastening member such as a bolt inserted into the hole 111d and the hole 112d.

The reinforcing member 112 is made of a material containing iron, aluminum, or magnesium. In the embodiment, the reinforcing member 112 is made of iron. When the reinforcing member 112 is made of the same material as that of the base member 111, the reinforcing member 112 may be formed integrally with the base member 111.

As shown in FIGS. 1 to 3, the base member 111 is detachably connected to each of the second support portion 120 and a leg portion 130 described later at a first connecting portion 113 which is an end portion located on the second support portion 120 side. The first connecting portion 113 includes an orthogonal surface which is orthogonal to the vehicle width direction.

In the embodiment, a connecting member 113a is inserted into a hole provided in the orthogonal surface of the first connecting portion 113 to penetrate in the vehicle width direction. The base member 111 and the second support portion 120 are detachably connected by the connecting member 113a. In the embodiment, the connecting member 113a is a bolt, but the connecting member 113a is not limited to a bolt as long as the first support portion 110 and the second support portion 120 are detachably connected. Moreover, the first support portion 110 and the second support portion 120 may just be connected detachably, and the connection method is not limited to fastening.

FIG. 5 is a cross-sectional view of the instrument panel reinforcement shown in FIG. 3 when seen in the direction of arrows of line V-V. As shown in FIG. 5, the first connecting portion 113 includes an E-shaped cross-sectional shape which is open to the rear Y2 side in the vehicle front-rear direction when seen in a direction perpendicular to the extending direction of the base member 111. The first connecting portion 113 includes a rib 113b which extends toward the rear Y2 side in the vehicle front-rear direction at the center of the first connecting portion 113 in the vertical direction.

With such a configuration, the connecting member 113a can be attachably and detachably mounted in an open space on the rear Y2 side in the vehicle front-rear direction while a strength of the first connecting portion 113 is maintained by the rib 113b. As described above, the second support portion 120 is detachably connected to the first support portion 110.

As shown in FIGS. 1 to 3, the base member 111 includes the lower steering support portion 114 at a position adjacent to the first connecting portion 113 in the vehicle width direction. A mounting bolt 114a is fixed to the lower steering support portion 114. The mounting bolt 114a extends toward the lower Z2 side in the vehicle vertical direction. A steering mechanism is mounted on the lower steering support portion 114 using the mounting bolt 114a. Thus, the first support portion 110 supports the steering mechanism.

In the embodiment, the lower steering support portion 114 is integrally formed as a part of the base member 111. Thus, the fastening member for mounting the lower steering support portion 114 on the base member 111 becomes unnecessary. Accordingly, while the number of parts of the instrument panel reinforcement 100 can be reduced, a weight of the instrument panel reinforcement 100 can be reduced.

As shown in FIGS. 1 to 3, a front steering support portion 115 is mounted on the front Y1 side of the lower steering support portion 114 in the vehicle front-rear direction. An upper steering support portion (not shown) is mounted on an upper surface of each of the lower steering support portion 114 and the front steering support portion 115. Further, an end portion of the front steering support portion 115 on the front Y1 side in the vehicle front-rear direction is joined to the vehicle body.

In the embodiment, the front steering support portion 115 is made of a material different from a material of the base member 111. The front steering support portion 115 is made of iron. Therefore, when an impact is applied to a position at which the steering mechanism is mounted in the instrument panel reinforcement 100 from the front Y1 side in the vehicle front-rear direction, the front steering support portion 115 made of iron can absorb the impact by extending and being deformed due to the impact.

Also, the front steering support portion 115 may be made of the same material as that of the base member 111. Moreover, the front steering support portion 115 may be made of a material containing aluminum or magnesium.

As shown in FIGS. 1 and 2, a central reinforcing portion 116 is joined to the front Y1 side of the base member 111 in the vehicle front-rear direction at a substantially central portion of the base member 111 in the vehicle width direction. The central reinforcing portion 116 is joined to the vehicle body at a surface of the central reinforcing portion 116 located on the front Y1 side in the vehicle front-rear direction.

In the embodiment, the central reinforcing portion 116 is made of a material different from a material of the base member 111. The central reinforcing portion 116 is made of iron. Therefore, when an impact is applied to a substantially central position of the first support portion 110 in the vehicle width direction with respect to the instrument panel reinforcement 100 from the front Y1 side in the vehicle front-rear direction, the central reinforcing portion 116 made of iron can absorb the impact by extending and being deformed due to the impact.

In addition, the central reinforcing portion 116 may be made of the same material as that of the base member 111. Moreover, the central reinforcing portion 116 may be made of a material containing aluminum or magnesium.

As shown in FIGS. 1 to 3, a side leg portion 117 is mounted on the rear Y2 side of the base member 111 in the vehicle front-rear direction at a substantially central portion of the base member 111 in the vehicle width direction. An upper end portion 117a of the side leg portion 117 is joined to the base member 111. The upper end portion 117a of the side leg portion 117 is located at the lower steering support portion 114 on the side opposite to the second support portion 120 side.

The side leg portion 117 extends obliquely downward toward a side portion of the vehicle opposite to the second support portion 120 side. A lower end portion 117b of the side leg portion 117 is joined to the side portion of the vehicle.

In the embodiment, the side leg portion 117 is made of iron. Further, the side leg portion 117 may be made of the same material as that of the base member 111. Moreover, the side leg portion 117 may be made of a material containing aluminum or magnesium.

As shown in FIGS. 1 to 3, the second support portion 120 extends in the vehicle width direction. The second support portion 120 is fixed to the side portion of the vehicle body at a mounting portion 121 located at the end on the side opposite to the first support portion 110 side.

The second support portion 120 is detachably connected to the first connecting portion 113 of the first support portion 110 at the second connecting portion 122 located at the end on the first support portion 110 side.

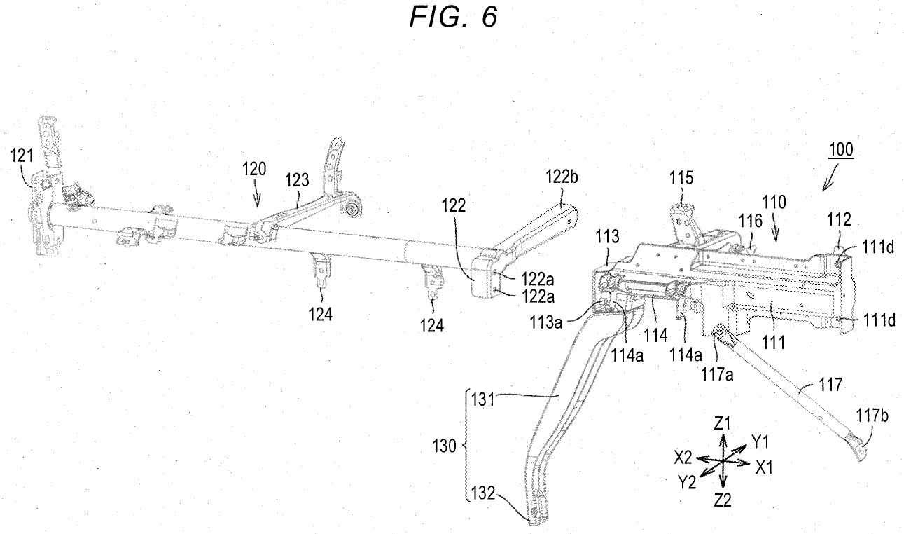

FIG. 6 is a perspective view showing a state in which the connection between the first support portion and the second support portion is released in the instrument panel reinforcement according to the embodiment of the present disclosure. As shown in FIG. 6, in the second support portion 120, a plurality of female screws 122a is provided in a surface of the second connecting portion 122 which faces the first support portion 110 side. The first support portion 110 and the second support portion 120 are connected to each other by fastening each of the female screws 122a to the connecting member 113a.

As shown in FIGS. 1, 2 and 6, a first front support portion 122b which extends from the second connecting portion 122 toward the front Y1 side in the vehicle front-rear direction is provided at the second support portion 120. The first front support portion 122b is fixed to the vehicle body at an end portion of the first front support portion 122b on the front Y1 side in the vehicle front-rear direction.

A second front support portion 123 which extends from a substantially central portion of the second support portion 120 in the vehicle width direction toward the front Y1 side in the vehicle front-rear direction is provided at the second support portion 120. The second front support portion 123 is fixed to the vehicle body at an end portion of the second front support portion 123 on the front Y1 side in the vehicle front-rear direction.

In the second support portion 120, a plurality of suspending portions 124 is provided between the second connecting portion 122 and the second front support portion 123. A functional part is suspended from the suspending portion 124. The functional part is, for example, an air conditioner.

In the embodiment, the second support portion 120 is made of iron. That is, in the embodiment, each of the mounting portion 121, the second connecting portion 122, the first front support portion 122b, the second front support portion 123, and the suspending portion 124 is made of iron.

As shown in FIGS. 1 to 3 and 5, in the embodiment, the leg portion 130 is connected to a lower side of the first support portion 110 and extends in the vertical direction in the vehicle vertical direction. As shown in FIG. 3, when the leg portion 130 is seen from the rear Y2 side in the vehicle front-rear direction, a lateral width of the leg portion 130 is gradually narrowed from an upper end portion toward a lower end portion.

The leg portion 130 includes an upper leg portion 131 and a lower leg portion 132 which is continuous with the upper leg portion 131 on the lower side of the upper leg portion 131. As shown in FIG. 5, an upper end surface of the upper leg portion 131 and a lower end surface, of the first connecting portion 113 of the base member 111 in the first support portion 110 are fixed to each other by the connecting member 133. In the embodiment, the connecting member 133 is a bolt. The connecting member 133 is not limited to the bolt. Moreover, the connection method of the first support portion 110 and the leg portion 130 is not limited to the fastening.

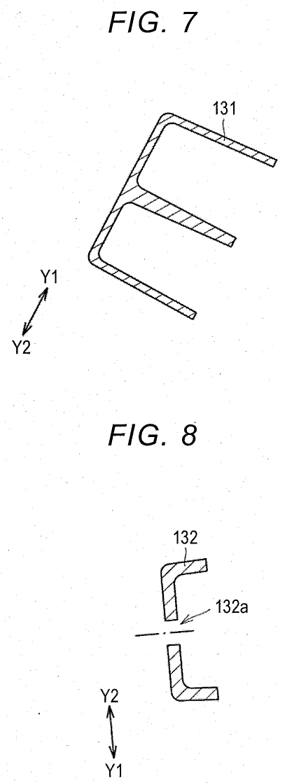

FIG. 7 is a cross-sectional view of the instrument panel reinforcement 100 shown in FIG. 3 when seen in a direction of arrows of line VII-VII. FIG. 7 shows a cross section perpendicular to the extending direction of the upper leg portion 131.

As shown in FIGS. 3, 5, and 7, the upper leg portion 131 is configured to have a substantially E-shaped cross-sectional shape in a cross section perpendicular to the extending direction of the upper leg portion 131. The upper leg portion 131 includes a rib 131a located at a center thereof in the vehicle front-rear direction. Thus, strength of the upper leg portion 131 can be ensured while a weight of the upper leg portion 131 is reduced.

FIG. 8 is a cross-sectional view of the instrument panel reinforcement shown in FIG. 3 when seen in a direction of arrows of line VIII-VIII. FIG. 8 shows a cross section perpendicular to the extending direction of the lower leg portion 132.

As shown in FIG. 8, the lower leg portion 132 includes a hole 132a. The lower leg portion 132 is fixed to a lower portion of the vehicle body by a fastening member such as a bolt inserted into the hole 132a.

In the embodiment, the lower leg portion 132 is configured to have a substantially C-shaped cross-sectional shape in a cross section perpendicular to the extending direction of the lower leg portion 132. An extension length of the lower leg portion 132 is shorter than that of the upper leg portion 131.

When a downward load acts on the first support portion 110 from the steering mechanism, the leg portion 130 joined to the vehicle body at the lower end portion supports the first support portion 110 from the lower side, and thus downward deformation of the instrument panel reinforcement 100 can be curbed.

The leg portion 130 is made of a material containing aluminum or magnesium. In the embodiment, the leg portion 130 is made of an aluminum alloy.

Here, a manufacturing method of the base member 111 of the first support portion 110 in the instrument panel reinforcement 100 according to the embodiment of the present disclosure will be described.

The base member 111 of the embodiment made of a magnesium alloy is formed by injection molding, specifically, thixomolding. In thixomolding, first, raw material chips such as magnesium chips formed by cutting a magnesium alloy are put into a cylinder of an injection molding machine. Then, the raw material chips are heated while compressed in the cylinder. The raw material chips heated at a tip end of the cylinder is melted to form a molten magnesium alloy. The molten magnesium alloy is injection-molded from the tip end of the cylinder to a mold. In this way, the molten magnesium alloy is molded without exposure to the atmosphere.

In the embodiment, generation of carbon dioxide can be curbed by forming the base member 111 by thixomolding. Further, since an amount of molten metal required for molding can be decreased, raw material cost can be reduced, and the base member 111 can be formed cheaply. In addition, since a molded product with good dimensional accuracy can be obtained by the thixomolding, a process in which the hole is provided by machining after injection molding can be eliminated by providing the hole by injection molding.

In the embodiment, a temperature of the molten magnesium alloy located at the tip end of the cylinder is maintained in a range in which the temperature of the molten magnesium alloy is equal to or higher than 600° C. and equal to or lower than 630° C. (in other words, within a range of 600° C. to 630° C.). That is, a molding temperature of the base member 111 in the embodiment is equal to or higher than 600° C. and equal to or lower than 630° C. Therefore, since the base member 111 is molded at a relatively low temperature, the strength of the base member 111 can be increased by making a crystal grain size of the magnesium alloy relatively small.

Next, in the embodiment, an experimental example in which the crystal grain size of the base member 111 made of a magnesium alloy is measured will be described.

The crystal grain size of the magnesium alloy constituting the base member 111 was measured by electron back scatter diffraction (EBSD).

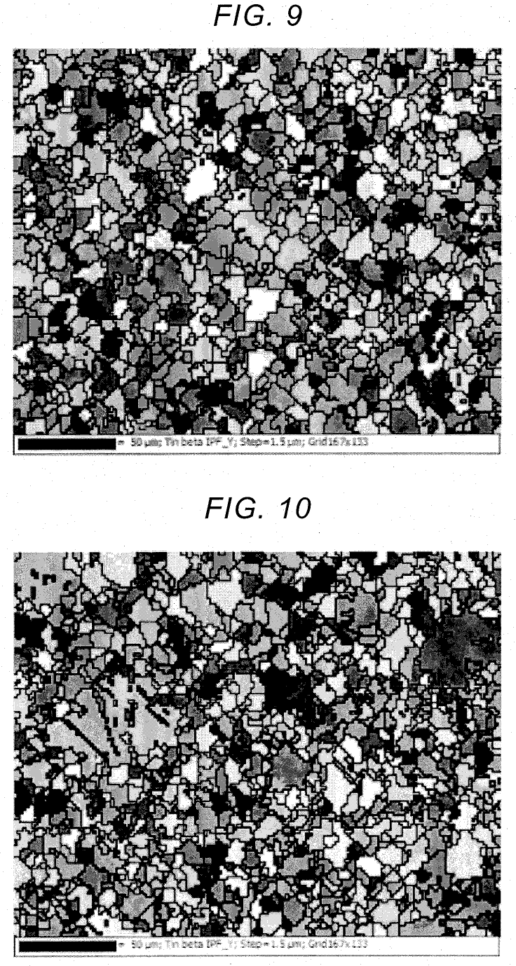

FIG. 9 is an SEM photograph showing a region in which the crystal grain size in the base member is measured in the instrument panel reinforcement according to the embodiment of the present disclosure. In the embodiment, the crystal grain size of the base member 111 was measured for a plurality of crystal grains present in a rectangular region having a horizontal length of 250 μm and a vertical length of 200 μm. In FIG. 9, each of the regions surrounded by a black line is one crystal grain. The number of measured crystal grains was 428.

The crystal grain size of the polycrystalline magnesium alloy constituting the base member 111 measured by the measurement method was within a range in which the crystal grain size is equal to or greater than 10.5 μm and equal to or smaller than 18.5 μm (in other words, within a range of 10.5 gm to 18.5 μm).

As described above, in one embodiment of the present disclosure, the polycrystalline magnesium alloy constituting the base member 111 does not include crystals having a grain size of smaller than 10.5 μm and crystals having a grain size of greater than 18.5 μm. That is, at least a part of the first support portion 110 is made-of a polycrystalline magnesium alloy which does not include crystals having a grain size of greater than 18.5 μm.

In the instrument panel reinforcement 100 according to the embodiment of the present disclosure, the first support portion 110 supports the steering mechanism. The second support portion 120 is disposed aligned with the first support portion 110 in the vehicle width direction and is detachably connected to the first support portion 110.

With such a configuration, when the instrument panel reinforcement 100 is transported, the handleability can be improved by separating and transporting the first support portion 110 and the second support portion 120, and since the first support portion 110 and the second support portion 120 are configured to be detachable, a part of the portion which extends in the vehicle width direction can be easily replaced.

In the instrument panel reinforcement 100 according to the embodiment of the present disclosure, at least a part of the first support portion 110 is made of a material containing magnesium or aluminum.

Each of magnesium and aluminum has a lower specific gravity than that of iron. Therefore, with such a configuration, it is possible to reduce the weight of the first support portion 110 as compared to a case in which the entire first support portion 110 is made of a material containing iron. Further, each of magnesium and aluminum has a higher strength to weight than that of iron. Therefore, with such a configuration, steering feeling of the steering mechanism supported by the first support portion 110 can be improved.

In addition, the first support portion 110 may be made of a metal other than the material containing magnesium or aluminum.

In the instrument panel reinforcement 100 according to the embodiment of the present disclosure, the first support portion 110 includes the base member 111 and the reinforcing member 112. The base member 111 extends in the vehicle width direction. The reinforcing member 112 is joined to the front side of the base member 111 in the vehicle front-rear direction. The base member 111 is made of a material containing magnesium or aluminum. The reinforcing member 112 is made of iron.

Iron has higher bending rigidity and higher ductility than each of magnesium and aluminum. Therefore, when an impact is applied to the instrument panel reinforcement 100 from the front side of the vehicle, with such a configuration, the reinforcing member 112 made of iron absorbs the impact by extending and being deformed due to the impact. Further, each of magnesium and aluminum has a higher impact strength than that of iron. Thus, the base member 111 made of a material containing magnesium or aluminum can suppress the first support portion 110 from being curved toward the vehicle rear Y2 side, that is, the driver side. In this way, the instrument panel reinforcement 100 according to the embodiment can improve collision safety of the vehicle by such a configuration.

The reinforcing member 112 may be made of a metal other than iron. Also, the reinforcing member 112 may be made of the same material as that of the base member 111.

In the instrument panel reinforcement 100 according to the embodiment of the present disclosure, the leg portion 130 is connected to the lower side of the first support portion 110 and extends in the vertical direction. The leg portion 130 is made of a material containing aluminum or magnesium.

Since the leg portion 130 is made of a material containing aluminum or magnesium having a strength to weight higher than that of iron, the weight of the leg portion 130 can be reduced, and when a downward load is applied to the first support portion 110 from the steering mechanism, downward deformation of the instrument panel reinforcement 100 can be curbed. In addition, the leg portion 130 may be made of a metal other than the material containing aluminum or magnesium.

In the instrument panel reinforcement 100 according to the embodiment of the present disclosure, the second support portion 120 is made of iron.

With such a configuration, when a functional part such as an air conditioner is mounted to be suspended from the second support portion 120, it is possible to suppress the second support portion 120 from being curved downward due to the weight of the functional part because iron has high bending rigidity. In addition, the second support portion 120 may be made of a metal other than iron.

In the instrument panel reinforcement 100 according to the embodiment of the present disclosure, at least a part of the first support portion 110 is made of a polycrystalline magnesium alloy. The polycrystalline magnesium alloy does not include crystals with a grain size greater than 18.5 μm. That, is, in the embodiment, at least a part of the first support portion 110 is made of a polycrystalline magnesium alloy including only crystals having a relatively small grain size.

Here, it is known that, for polycrystalline metals, Hall-Petch equation shown in the following Equation (1) is empirically established.

$${σ}_{y} = {σ}_{f} + \frac{k}{\sqrt{d}} \qquad ( 1 )$$

d is an average crystal grain size, σ_{y} is a yield stress, σ_{f} is 0.2% proof stress, and k is a material constant determined for each type of metal. That is, as the crystal grain size is reduced, the strength becomes higher. Therefore, in the embodiment, the strength of the instrument panel reinforcement 100 can be improved by the configuration in which the base member 111 is made of a polycrystalline magnesium alloy containing only crystals having a relatively small grain size.

Also, at least a part of the first support portion 110 may be made of an aluminum alloy having a strength to weight higher than that of a magnesium alloy.

The manufacturing method of the base member 111 of the first support portion 110 is not limited to the thixomolding method. The base member may be molded using a method other than the thixomolding method, for example, a die casting method. When the base member is molded using the die casting method, the crystal grain size of the polycrystalline magnesium constituting the base member is different from that when the base member is molded using the thixomolding method. Hereinafter, a manufacturing method of an instrument panel reinforcement according to a modified example of the embodiment of the present disclosure will be described.

In the instrument panel reinforcement according to the modified example of the embodiment of the present disclosure, the base member is made of a magnesium alloy formed by a die casting method. The die casting method is a casting method in which a molten metal material is pressed into a mold.

In the modified example, a temperature at which the molten magnesium alloy is pressed into the mold is maintained in a range in which the temperature is equal to or higher than 660° C. and equal to or lower than 670° C. (in other words, within a range of 660° C. to 670° C.). That is, a molding temperature of the base member according to the modified example is equal to or higher than 660° C. and equal to or lower than 670° C. The molding temperature is higher than that in the thixomolding method in the embodiment of the present disclosure.

Next, an experimental example in which the crystal grain size of the base member made of a magnesium alloy according to the modified example is measured will be described.

Like the crystal grain size of the magnesium alloy constituting the base member of the embodiment of the present disclosure, the crystal grain size of the magnesium alloy constituting the base member of the modified example was measured by the EBSD method.

FIG. 10 is an SEM photograph showing a region in which the crystal grain size in the base member is measured in the instrument panel reinforcement according to the modified example of the embodiment of the present disclosure. In the modified example, regarding the base member, the crystal grain size was measured for a plurality of crystal grains present in a rectangular region having a horizontal length of 250 μm and a vertical length of 200 μm. In FIG. 10, each of the regions surrounded by a black line is one crystal grain. The number of measured crystal grains was 487.

As shown in FIGS. 9 and 10, it can be understood that the crystal grains of the polycrystalline magnesium alloy constituting the base member according to the modified example include crystals having a relatively large crystal grain size.

The crystal grain size of the polycrystalline magnesium alloy constituting the base member 111 according to the modified example was in a range in which the crystal grain size of the polycrystalline magnesium alloy is equal to or greater than 7.0 μm and equal to or smaller than 35 μm (in other words, within a range of 7.0 μm to 35 μm). That is, unlike the base member 111 according to the embodiment of the present disclosure, the base member according to the modified example includes crystals having a relatively large grain size of greater than 18.5 μm.

Accordingly, due to the Hall-Petch equation shown in Equation (1), the base member 111 molded by the thixomolding method according to the embodiment of the present disclosure has higher strength than that of the base member molded by the die casting method according to the modified example.

Further, the base member 111 molded by the thixomolding method according to the embodiment of the present disclosure has less variation in the crystal grain size of the polycrystalline magnesium alloy than that of the base member molded by the die casting method according to the modified example Thus, the base member 111 molded by the thixomolding method according to the embodiment of the present disclosure can reduce variations in the strength and can further stabilize characteristics of the instrument panel reinforcement.

It should be considered that the embodiment disclosed this time is an illustration and restrictive at no points. The scope of the present disclosure is defined by the claims rather than the above description and is intended to include any modifications within the scope and meaning equivalent to the claims.

At least a part of the first support portion may be made of a material containing magnesium or aluminum.

The first support portion may include a base member and a reinforcing member. The base member extends in the vehicle width direction. The reinforcing member may be joined to a front side of the base member in the vehicle front-rear direction.

The base member may be made of a material containing magnesium or aluminum. The reinforcing member may be made of iron.

The instrument panel reinforcement may further include a leg portion. The leg portion may be connected to a lower side of the first support portion and may extend in the vertical direction. The leg portion may be made of a material containing aluminum or magnesium.

The second support portion may be made of iron. At least a part of the first support portion may be made of a polycrystalline magnesium alloy. The polycrystalline magnesium alloy may not include crystals with a grain size of greater than 18.5 μm.

With such a configuration, handleability at the time of transportation can be improved, and a part of the portion which extends in the vehicle width direction can be easily replaced.

What is claimed is:

1. An instrument panel reinforcement which extends in a vehicle width direction and of which both ends are fixed to a side surface of a vehicle at positions on a front side of an instrument panel in a vehicle front-rear direction, comprising:
a first support portion configured to support a steering mechanism; and
a second support portion disposed aligned with the first support portion in the vehicle width direction and detachably connected to the first support portion.

2. The instrument panel reinforcement according to claim 1, wherein at least a part of the first support portion is made of a material containing magnesium or aluminum.

3. The instrument panel reinforcement according to claim 2, wherein:
the first support portion includes a base member configured to extend in the vehicle width direction, and a reinforcing member joined to a front side of the base member in the vehicle front-rear direction,
the base member is made of the material containing magnesium or aluminum, and
the reinforcing member is made of iron.

4. The instrument panel reinforcement according to claim 1, further comprising a leg portion connected to a lower side of the first support portion and configured to extend in a vertical direction,
wherein the leg portion is formed of a material containing magnesium or aluminum.

5. The instrument panel reinforcement according to claim 1, wherein the second support portion is made of iron.

6. The instrument panel reinforcement according to claim 1, wherein at least a part of the first support portion is made of a polycrystalline magnesium alloy, and the polycrystalline magnesium alloy does not include crystals having a grain size of greater than 18.5 μm.
